(19) United States
(12) Patent Application Publication
(10) Pub. No.: US 2015/0125210 A1
(43) Pub. Date: May 7, 2015

(54) EXCAVATED UNDERGROUND CAVERNS FOR FLUID STORAGE

(71) Applicant: General Compression, Inc., Newton, MA (US)

(72) Inventors: Eric D. Ingersoll, Cambridge, MA (US); Preston Carter, Waltham, MA (US)

(21) Appl. No.: 14/400,146

(22) PCT Filed: May 17, 2013
(86) PCT No.: PCT/US2013/041576

§ 371 Date: Nov. 10, 2014

Related U.S. Application Data
(60) Provisional application No. 61/648,972, filed on May 18, 2012.

(51) Int. Cl. B65G 5/00; F02C 9/16; F02C 6/16

(52) U.S. Cl. CPC B65G 5/00; F02C 6/16; F02C 9/16
USPC 405/55

(57) ABSTRACT

An underground fluid storage structures formed by mechanical excavation of a subsurface formation in a controlled fashion. The structure comprises vertical holes (260, 270) and transversal caverns (256) of circular section and preferably in spiral arrangement. Storage caverns as described herein may further employ hydraulic pressure compensation to prevent wide pressure variations in the storage caverns, and to provide relatively constant injection and discharge pressures when introducing or releasing stored fluids. The preferred application is compressed air energy storage (CAES) systems for storing energy in the form of compressed air in order to generate electricity.

### CROSS-REFERENCE TO RELATED APPLICATION

This application claims priority to and the benefit of U.S. Provisional Patent Application No. 61/648,972, filed May 18, 2012, and entitled “Excavated Underground Caverns for Fluid Storage,” the entirety of which is hereby incorporated herein by reference.

### FIELD OF THE INVENTION

The disclosed embodiments relate generally to systems and methods for storing a fluid, and particularly to systems and methods for storing compressed gas, such as air or natural gas.

### BACKGROUND

Subsurface storage structures may be employed for the storage of fluids, e.g., natural gas, hydrocarbons liquids, air, carbon dioxide and/or other gases. Conventional subsurface storage may include depleted hydrocarbon-bearing reservoirs which exhibit suitable permeability and porosity, and which exhibit suitable pressure retention characteristics (e.g., provided by a shale cap or other geologic features) to retain the stored fluid for later retrieval. However, the use of depleted hydrocarbon reservoirs may be limited for some storage applications. For example, the use of depleted hydrocarbon bearing zones is limited by the location of such formations, which may be in remote areas and distant from sites where storage is desired. Furthermore, the use of depleted hydrocarbon formations may be limited by the dynamic characteristics of the formation. For example, certain fluid storage applications may require relatively rapid injection and/or removal of the stored fluid. Accordingly, such applications may not be compatible with formations wherein the permeability and porosity characteristics of the formation do not permit sufficient injection and/or withdrawal rates. Thus, suitably located depleted hydrocarbon formations, having appropriate permeability, porosity, and flow characteristics may be unavailable for a given storage application. Furthermore, the storage capacity of the formation is fixed and is contingent on the size of the formation employed.

Porous geologic formations that are positioned with respect to relatively non-porous formations in a manner that provides containment of a fluid are used for storage of air, hydrocarbons, and other fluids. Examples of embodiments of this include depleted hydrocarbon reservoirs and confined aquifers. In a general sense, any combination of geologic phenomena that creates a low permeability trap for fluids have the potential for storage of air, hydrocarbon, or other fluids. The broad geologic characteristics of traps are classified as structural traps, stratigraphic traps, and hydrodynamic traps. The trapping mechanisms for a storage volume may be achieved with one or any combination of these mechanisms. The pressurization of these storage volumes is primarily achieved from the in-situ hydrostatic pressure of the volume and contribution from the in-situ lithostatic pressure of the overburden.

Another type of conventional underground structure for fluid storage structure is a salt cavern. Salt caverns may be formed in subterranean salt layers by, e.g., drilling into the salt layer using conventional rotary drilling techniques, then solution mining the salt by introduction of fresh water to the salt formation. The saturated brine produced by dissolution of the salt is then removed and the process is repeated. The solution mining is performed continuously (i.e., fresh water is injected at the same time saturated brine is being removed) until the salt cavern reaches the desired size. Solution mining of salt beds and domes may be a time consuming process, and typically produces large quantities of brine which must be treated and/or disposed of. In addition, the use of salt caverns for fluid storage, like depleted hydrocarbon formations, is limited by the geographical location of salt formations, which may not be convenient or appropriate for a desired fluid storage need or application. Further, like depleted hydrocarbon reservoirs, salt caverns are constrained in size, and accordingly, storage volume, by the corresponding size of a salt formation from which the salt cavern is mined.

Another alternative for underground storage of fluids is excavated caverns formed by blasting. Such excavated caverns may include depleted mines or similar cavern-like structures formed using traditional blasting techniques. However, blasting employed in the formation of such structures typically produces fractures of the surrounding rock formations, and may also weaken the surrounding rock. Accordingly, the fractures may result in structures which are not suitable to contain stored fluids under pressure. For example, a blasted cavern may have lateral, vertical, or angular fissures that allow stored fluids to escape or migrate out of the storage cavern. Such losses are generally unacceptable, particularly in fluid storage applications where pressurized fluids are retained (e.g., compressed gas storage). Furthermore, blasting may damage the integrity of the overburden rock, requiring extensive bracing and/or shoring to keep the resultant cavern open. In addition, blasting may produce large, irregular debris which may require grinding or other size reduction prior to removal. Further, blasting to form caverns may not be suitable for certain locations (e.g., densely populated areas), and thus the location of blasted caverns may be limited.

Accordingly, there exists a need for underground fluid storage facilities which can be constructed in a cost effective fashion, are scalable in size, and can be located conveniently for a given application.

### SUMMARY OF THE INVENTION

The present application describes underground storage caverns that may be formed by mechanical excavation of a subsurface formation in a controlled fashion. In some embodiments, the present application provides storage caverns formed by employing tunnel boring techniques, which may be substantially horizontal or slightly inclined. The caverns may be formed in a controlled fashion, are scalable, and may employ geometries to maximize storage volumes while minimizing the surface area of land associated with the storage facility. In addition, the caverns may be formed in a wide array of geologic formations and they may be located essentially anywhere a suitable geologic formation is located regardless of, for example, population density. Storage caverns as described herein may further employ hydraulic pressure compensation to manage wide pressure variations in the storage caverns, and to provide relatively constant injection and discharge pressures when introducing or releasing stored fluids. In some embodiments, the caverns may be employed in a compressed air energy storage (CAES) system for storing energy in the form of compressed air. Alternatively, the present caverns may be employed for the storage of natural gas and hydrocarbon liquids. These embodiments are described herein.

Accordingly, in one aspect, a large-scale, excavated, underground storage system includes at least one substantially vertical borehole and a plurality of lateral caverns extending from the vertical borehole. The lateral caverns are adapted for substantially sealed storage of a fluid and are excavated by a tunnel boring machine. The diameter of each lateral cavern is less than or substantially equal to the diameter of the vertical borehole. Further, the lateral caverns are formed to substantially maximize the volume of the lateral caverns while substantially minimizing the total surface area of the storage subsystem.

In one embodiment, the storage system is fluidically coupled to a compressed air energy storage system. The diameter of the vertical borehole may be sized to receive the tunnel boring machine. Each lateral cavern may be either substantially horizontal or inclined. At least one of the lateral caverns may be fluidically isolated from at least one of the other lateral caverns. At least one of the lateral caverns may be fluidically coupled to a substantially vertical terminal borehole disposed at a terminal end of that lateral cavern.

In another embodiment, each lateral cavern includes a geometry selected from the group consisting of a line, a curve, a circle, a spiral, and combinations of the foregoing. Each lateral cavern may have a substantially similar geometry. At least one of the lateral caverns may have a circular cross-section. The lateral caverns may be arranged in a two-dimensional array and/or a three-dimensional array.

In a further implementation, the fluid is a liquid, a gas, a vapor, a suspension, an aerosol, or a combination of the foregoing. The depth of at least one of the lateral caverns may be selected based at least in part on a lithostatic pressure acting on that lateral cavern. The storage system may further include a pressure compensation system adapted to maintain a substantially constant working pressure in at least one of the lateral caverns, and the pressure compensation system may include a liquid displaceable by a gas stored in that lateral cavern.

In another aspect, a method for constructing a large-scale, excavated, underground storage system includes forming at least one substantially vertical borehole and excavating, by a tunnel boring machine, a plurality of lateral caverns extending from the vertical borehole. The lateral caverns are adapted for substantially sealed storage of a fluid, with each lateral cavern having a diameter less than or substantially equal to the diameter of the substantially vertical borehole. The lateral caverns are formed to substantially maximize the volume of the lateral caverns while substantially minimizing the total surface area of the storage subsystem.

In one embodiment, the method further includes fluidically coupling the storage system to a compressed air energy storage system. The diameter of the vertical borehole may be sized to receive the tunnel boring machine. Each lateral cavern may be either substantially horizontal or inclined. The method may further include fluidically isolating at least one of the lateral caverns from at least one of the other lateral caverns. The method may further include fluidically coupling at least one of the lateral caverns to a substantially vertical terminal borehole disposed at a terminal end of that lateral cavern.

In another embodiment, each lateral cavern includes a geometry selected from the group consisting of a line, a curve, a circle, a spiral, and combinations of the foregoing. Each lateral cavern may have a substantially similar geometry. At least one of the lateral caverns may have a circular cross-section. The method may further include arranging the lateral caverns in a two-dimensional array and/or a three-dimensional array.

In a further implementation, the fluid is a liquid, a gas, a vapor, a suspension, an aerosol, or a combination of the foregoing. The method may further include selecting the depth of at least one of the lateral caverns based at least in part on the lithostatic pressure acting on that lateral cavern. The method may further include maintaining a substantially constant working pressure in at least one of the lateral caverns, which may include displacing a liquid by storing a gas in that lateral cavern.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, emphasis instead generally being placed upon illustrating the principles of the invention.

FIG. 1 is a schematic illustration of an underground fluid storage system according to an embodiment.

FIG. 2 is a schematic illustration of an underground fluid storage system according to another embodiment.

FIG. 3A is a side view of a cavern storage structure according to an embodiment.

FIG. 3B is a side view of a cavern storage structure according to another embodiment.

FIG. 4 is a graph of pressure versus depth showing various k values which may be employed in selecting a suitable depth and pressure regime for the present cavern storage structures.

FIG. 5 is a graph of k values versus depth which may be employed in selecting a suitable depth and pressure regime for the present cavern storage structures.

FIG. 6A is a perspective view of a spiral cavern storage structure according to an embodiment.

FIG. 6B is a top view of the spiral cavern storage structure of FIG. 6A.

FIG. 7A is a perspective view of a plurality spiral cavern storage structures of FIG. 6A according to an embodiment.

FIG. 7B is a top view of the plurality of spiral storage structures of FIG. 7A.

FIG. 7C is a top view of a plurality of spiral storage structures according to an embodiment.

FIG. 8 is a top view of a plurality of storage structures of FIG. 7C arranged in a two-dimensional array.

FIG. 9 is perspective view of a plurality of storage structures of FIG. 7C arranged in a three-dimensional array.

FIG. 10 is a top view of a plurality of storage structures of FIGS. 7A-7C in a three-dimensional array.

### DETAILED DESCRIPTION

Systems and methods for the storage of a compressed gas (such as air, natural gas, hydrogen (H₂), helium (He) or argon (Ar)), or a liquid, in underground storage caverns are described herein. The underground storage caverns can be used, for example, to store hydrocarbons such as natural gas, natural gas liquids (NGL) or liquefied petroleum gases (LPG) for later recovery and use. The underground storage caverns can also be used, for example, to store energy in the form of compressed gas, such as air, in a compressed air energy storage (CAES) system. The caverns can have efficient/optimal operating ranges that can vary as a function of, for example, flow rate and pressure, among other parameters. Systems and methods of operating the storage caverns are provided to allow them to function at optimal performance throughout the energy storage cycle of the compressed gas energy storage system.

Throughout the present specification, the words “a” or “an” are understood to mean “one or more” unless explicitly stated otherwise. Further, the words “a” or “an” and the phrase “one or more” may be used interchangeably.

As used herein, “fluid” can mean a liquid, gas, vapor, suspension, aerosol, or any combination thereof. As used herein, “liquid” can include any suitable liquid fluid including, for example, water and/or brine (e.g. water substantially partially or completely saturated with salt), and “gas” can include any suitable gaseous fluid including, for example, air, natural gas, hydrogen (H₂), helium (He) or argon (Ar). A power grid can be any local, regional, national, and/or international power grid, grids, or combination of grids. A power source can include any source of power independent of fuel or production method, e.g., solar, wind, fossil fuel, nuclear, geothermal, hydroelectric, etc.

As described herein, in some embodiments, systems and methods can be used for manufacturing underground storage structures (also referred to herein as “underground storage caverns” or “caverns”). In some underground storage structures, a plurality of individual caverns can be constructed to optimize the installed storage capacity per surface area of land (i.e., storage density). In some embodiments, a tunnel boring machine (TBM) can be used to construct caverns for the underground storage structure.

In some embodiments, TBMs may be employed to construct underground storage structures. For example, a vertical boring having a diameter sufficient to introduce a TBM may be formed by, e.g., rotary drilling or excavation, to a desired depth. The TBM can then be lowered into the vertical boring, and a horizontal or substantially horizontal cavern can then be excavated from the base of the vertical borehole by boring with the TBM. TBM boring methods are known in the art, and typically employ a rotary cutting assembly which removes material at a cutting face. Debris cut away from the rock face is continuously transported from the cutting face to the vertical boring, where it is removed to the surface and disposed of Caverns as described may be bored at a slight incline (e.g., 0.1° to 3°) to aid in debris removal, to allow any fluids released during excavation to flow away from the cutting face, and to manage air and/or water traps when a compensating liquid is used for gas storage as described herein. In other embodiments, a vertical bored TBM or SRM tunnel of significant diameter and depth may be utilized directly as the fluidic storage vessel. The density could be further enhanced over traditional and alternative pumped hydro variations by employing gas as the compressible in unison with “pumped, controlled pressure operation of the storage cavity.” The gas can provide an energy density benefit up to six fold over these pumped hydro variations.

In some embodiments, drilling and blasting may be used to construct underground storage structures. For example, in certain types of rock (e.g., hard igneous rock, abrasive rock, silica-containing rock, etc.), modern drilling and blasting machines can be used to cost-effectively construct storage caverns. Such drilling and blasting machines typically use safer, more environmentally friendly explosives relative to traditional explosives. In drill-and-blast operations, a machine with a boom-mounted array of drill heads can be used to drill a predetermined pattern of holes in a rock formation to be excavated. The drills are then removed, explosives are inserted into the drilled holes, and then the explosives are detonated. The resultant explosion fragments the rock in the blast region of the rock face where the explosive were inserted, and those fragments can then be removed. The drill-and-blast machine can then be advance for additional material removal. Alternatively, a combination of drilling/blasting and boring excavation methods may be employed. For example, a drill-and-blast operation may be used to provide an initial excavation, or pilot hole, which may then be expanded or continued with a TBM to form a cavern structure as described herein.

The cavern may be constructed to any desired length (e.g., about 100 m to about 1 km or more) and cross-sectional area (e.g., an effective diameter from about 1 m to about 10 m or more) suitable for a particular storage application. Typically the caverns are elongated, with a relatively high length/diameter ratio. The horizontal cavern formed by the TBM typically has a circular cross-section, which may provide structural integrity and relative ease of excavation. Caverns formed by a TBM may have essentially any geometry, and are typically constrained only by the maneuvering capabilities of the TBM (e.g., minimum turning radius). For example, caverns formed by a TBM may be linear, curved (e.g., spirals, circles), or variations and combinations thereof (e.g., linear and curved portions may be combined in a single cavern structure).

The location and geometry of caverns as described herein may be determined by the extent of available surface real estate available for constructing such storage structures. Geometry for caverns may be selected in view of, or determined by, the geologic characteristics of a given rock formation where the caverns are to be constructed. For example, geometry for the present caverns may be selected to avoid geologic faults, which may compromise pressure and/or structural integrity of the cavern. In addition, it may be desirable to avoid certain rock formations (e.g., acidic rock formations), as disposal of debris from excavation of certain rock types may require special handling and disposal, which may be costly. Further, the location, depth and/or shape of caverns may be selected so that they are constructed in rock which displays desirable mechanical (e.g., rock strength) or fluid characteristics (e.g., permeability, porosity), or avoids those with unsuitable mechanical or fluid characteristics. For example, the location, depth and/or shape of caverns may be selected to avoid karst-prone geologic formations, as these may lack suitable mechanical and/or fluid integrity for construction of the present cavern structures. Location and construction of storage caverns may also be selected because of geologic formations due to ease of excavation of those formations. For example, a site may be selected where the rock is relatively easily removed (i.e., can be excavated at higher rates due to the mechanical characteristics of the rock), as rapid removal of rock may reduce the overall cost of cavern construction, for example, by reducing the operating and maintenance cost of the TBM. Accordingly, in certain embodiments, relatively soft geologic formations may be selected. In certain cases, TBMs may be employed to form the caverns in salt formations, as an alternative to solution mining of such formations.

In some embodiments, multiple caverns (e.g., two or more) can be constructed off a single vertical borehole to provide a series of caverns which can be interconnected via the central borehole. The two or more caverns can have the same geometry, or may have different geometries. In some embodiments, multiple caverns can be constructed with geometries to maximize cavern volumes while minimizing the total surface area of land used for the storage facility. For example, several caverns can be formed in nested spirals, as concentric circles, as parallel lines, etc. This can provide a cost effective method of creating large volumes of storage via the construction of multiple caverns off a single central vertical borehole while maximizing storage volume for a given area. In certain embodiments, two or more TBMs may be introduced into a single vertical borehole, and may be employed to simultaneously construct multiple caverns off a single central vertical borehole. In embodiments where two or more caverns are constructed from a central vertical borehole, the individual caverns may be fluidically isolated. Alternatively, each of the caverns may be connected to other caverns, or the caverns may be connected in subgroups which are fluidically isolated from other subgroups of caverns off a central borehole.

The caverns may also be constructed in a vertical array. For example, one or more caverns may be constructed at a selected depth, and then one or more caverns can subsequently be constructed at another depth either above or below the depth of the first array of caverns. Thus, in some embodiments, the geometries of an array of caverns at one depth may be selected to provide maximum storage density at a given depth, then one or more similar arrays may be constructed to provide additional storage density for a given area, as described above with respect to fluidic isolation of horizontal arrays of caverns.

Embodiments of the caverns may have depths from about 400 m to about 2,000 m, although the specific depth of the storage caverns can be selected in view of the required operational characteristics of the caverns for a given application. For example, the depth of the caverns can be selected in view of the desired working or operating pressures for a selected storage application. In certain embodiments, the depth of a cavern can be selected such that the lithostatic pressure is approximately equivalent to a desired operating pressure of the storage structure. Thus, for high pressure applications (e.g., storage of compressed gases) a deeper cavern may be constructed to provide sufficient lithostatic pressure from the overburden to provide a storage cavern which will withstand high storage pressures. Alternatively, where lower working pressures may be employed, e.g., for the storage of liquids, shallower caverns may be employed.

In some embodiments, the geologic characteristics of the rock formation in which the present caverns are constructed may be sufficient to retain the stored fluids at the working pressures employed in the storage facility. For example, certain types of rock (e.g., shale) possess low permeability, low porosity, or both, and the rock formation may provide fluidic isolation of a cavern for the storage of gases. In other embodiments, where liquids are to be stored in the cavern, pressure sealing may be unnecessary as the liquid may not migrate at sufficient rates or in sufficient quantities to warrant the cost of lining the caverns. However, in some embodiments, where the caverns are constructed in rock which is not pressure competent, e.g., the caverns will not retain fluids at the working pressure employed in storage due to rock properties (e.g., permeability, porosity) or naturally occurring fissures and/or fractures, the caverns can be sealed to provide pressure integrity. Sealing methods include linings such as, for example, spraying a suitable lining material on the walls of the cavern (e.g., concrete, “shotcrete”) or by lining the cavern with a pipe. Alternatively, a lining can be created by filling the cavern with a slurry having a sealing material (e.g., cement, bentonite), and “squeezing” the sealing material into the walls of the cavern by pressurizing the cavern filled with the slurry material. The slurry can then be removed, effectively providing a pressure competent seal to the cavern. In other embodiments, a desired shallower depth or sub optimal geologic characteristics may not be sufficient to solely rely on geostatic pressure for containment. An optimized lining or pressure vessel could be utilized to help contain dense fluidic storage while not needing the same mechanical properties or safety margin that would be mandated at the surface.

After formation of a desired number of cavern structures, removal of the excavation debris, and optionally sealing of the caverns, the storage structure can be isolated and connected to the surface to provide for introduction and removal of fluids to be stored. Traditional sealing methods, including lining the central borehole with a liner pipe and cementing the same in place may be employed. However, given the significant diameter of the vertical access boring through which a TBM is lowered, alternative methods may be employed to control the costs associated with lining the vertical boring. For example, a lining (e.g., concrete or “shotcrete”) may be applied. Alternatively, as described above with respect to tunnel sealing, the vertical borehole may be sealed by employing squeeze techniques. In other embodiments, the vertical boring may only be sealed for a fixed depth above the top of the cavern structures, and a mechanical seal (e.g., a concrete barrier) may be affixed above the lined portion, sealing the cavern structures but alleviating the need for lining of the entire vertical borehole. Alternatively, in some embodiments each cavern off a central borehole may be individually sealed by, e.g., installation of a mechanical barrier to provide pressure isolation of individual caverns off a central boring where two or more caverns off the central boring have been constructed, for example, an embodiment may include storage of more than one type of fluid, or different storage pressures of a single fluid.

Fluid communication between the surface and the storage facility may be provided by conventional pipe installation such as that used in production of hydrocarbon fluids (e.g., casing). Such casing can provide a fluid conduit to a storage cavern that may have one or more interconnected caverns. Alternatively, multiple casing strings can be run to individual caverns, to provide compartmentalized storage in each individual cavern, where such fluidic isolation is desired. Such casing strings can be connected to a manifold at the surface to provide controlled isolation of individual caverns, and selective introduction and/or removal of stored fluids. Alternatively, a plurality of interconnected caverns may be connected to the surface via a single casing string. The pressure rating of individual casing strings may be selected in view of the working pressures of the storage system to be employed, and the diameter of casings may be selected in view of the flow rates required for introduction and removal of the stored fluid.

For example, in certain embodiments, the caverns can be used to store compressed air for later energy generation. Turbines, pumps, or other devices employed to harness the energy provided by release and expansion of compressed air may require relatively constant supply pressure for safe and efficient operation. Hydraulic pressure compensation systems may be employed, using a suitable working fluid such as water or brine. Alternatively, pressure compensation systems may be used to aid in removal of, e.g., stored liquids by displacement of the stored liquids. For example, hydrocarbon liquids are less dense than water, and thus the introduction of aqueous pressure compensation fluids such as water or brine into the present storage caverns will displace stored hydrocarbon liquid, maintain the cavern pressure, and aid in removal of the stored liquid. In gas storage applications, a pressure compensation fluid can also aid in production of the stored fluid, and can maintain a desired pressure and temperature in the storage cavern to prevent pressure cycling of the cavern and minimize the rate of strain on the cavern wall faces.

In some embodiments, the storage structures can be used to store compressed air in a compressed air energy storage system (CAES). CAES systems are a type of system for storing energy in the form of compressed air. CAES systems can be used to store energy when electricity demand is low, typically during the night, and then to release the energy when demand is high, typically during the day, as described in U.S. Patent Publication. No. 2012/0057997, entitled “Systems and Methods for Optimizing Thermal Efficiency of a Compressed Air Energy Storage System,” the disclosure of which is incorporated herein by reference in its entirety. Thus, in certain embodiments, CAES systems may be coupled to the underground storage caverns provided herein to store compressed air for energy storage and subsequent generation.

CAES systems may be used in conjunction with the present bored cavern structures. For example, while CAES systems may be coupled to conventional underground storage structures (e.g., depleted hydrocarbon reservoirs, salt domes), as described herein, the location of such conventional underground storage structures is limited to where those structures naturally occur. Conversely, bored tunnel storage caverns can be constructed anywhere suitable rock is found, which is generally in most locations. Accordingly, the location of a CAES system is not particularly constrained, and such facilities can be placed where energy storage and delivery is needed (e.g., near power lines, near urban areas, etc.) or where excess power generation is available (e.g., wind turbine farms, nuclear power plants, etc.).

In some embodiments, a pressure compensation system may be employed to maintain relatively constant working pressures in the storage caverns. Pressure cycling, e.g., pressure variations during introduction and discharge of a stored fluid may affect the mechanical properties of the rock in which the caverns are constructed. Further, such pressure cycling may compromise the integrity of cavern linings, where such linings are employed. Thus, in some embodiments, the storage structure may use a pressure compensation system to minimize pressure cycling. Such pressure compensation may provide relatively constant deliver pressures of stored fluids.

For example, an embodiment of the storage structure can include a first storage location disposed at a first elevation, the first storage location configured to contain a liquid and a gas. The first storage location is further configured to receive compressed gas from a compressor and is in fluid communication with a second storage location disposed at a second elevation, the second elevation greater than the first elevation. The second storage location is configured to contain a volume of liquid such that the volume of liquid contained within the second storage location imparts a hydrostatic pressure on the first storage location. The first and second storage locations are configured to allow at least a portion of the liquid contained in the first storage location to flow from the first storage location to the second storage location as compressed gas is moved into the first storage location from the compressor/expander device. The first and second storage locations are further configured to allow at least a portion of the liquid contained in the second storage location to flow from the second storage location to the first storage location as compressed gas is removed from the first storage location.

In some storage systems, the second storage location can be elevated relative to a first storage location, and a liquid contained in the second storage location can maintain a pressure and/or range of pressures within the first storage location. As compressed gas is delivered to the first storage location, a portion of the liquid contained in the first storage location is displaced to the second storage location at a higher elevation than the first storage location. Once a desired amount of the liquid has been displaced from the first storage location to the second storage location, the first storage location can be fluidically isolated from the second storage location with, for example, a valve, thus allowing the first storage location to further be pressurized with compressed gas without inducing additional liquid flow from the first storage location to the second storage location. For example, in some embodiments, in may be desirable to move substantially all of the liquid from the first storage location to the second storage location before closing the valve to fluidically isolate the two storage locations. In other embodiments, it may be desirable to only move a portion of the liquid from the first storage location to the second storage location depending on, for example, the capacity of the second storage location or other operational parameters. As compressed gas is removed from the first storage location, a portion of the liquid contained in the second storage location can flow into the first storage location to occupy a volume in the first storage location previously occupied by the mass of the compressed gas that has been removed. In this manner, substantially all of the compressed gas contained in the first storage location can be released from the first storage location and delivered to a compressor/expander device, thus utilizing the entire volume of the cavern for energy storage in the form of compressed gas while maintaining a desired minimum pressure for the gas contained in the first storage location.

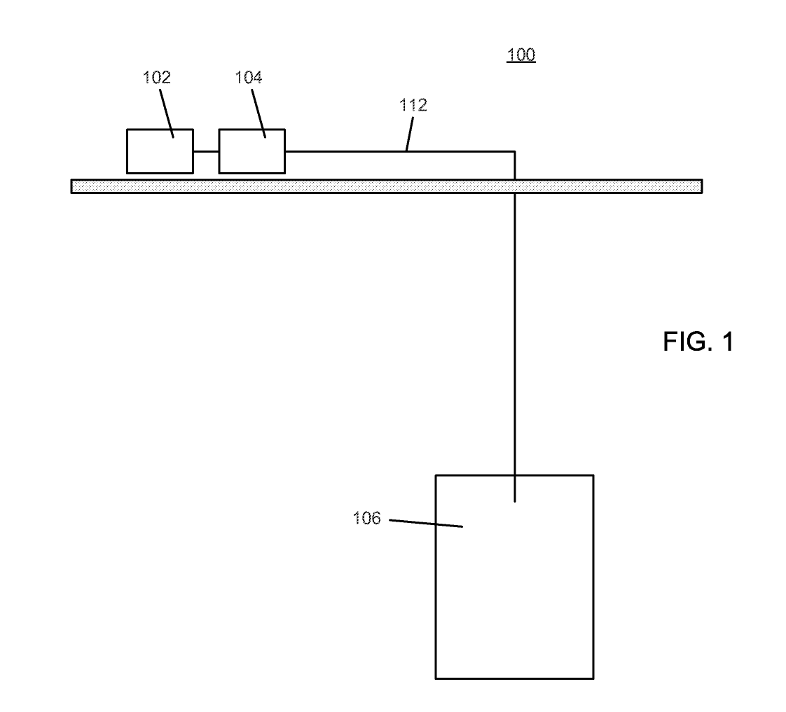

FIG. 1 is a schematic illustration of a compressed gas storage/compressed gas energy storage system 100. For simplicity in rendering the present cavern structures, FIG. 1 shows a cross section of a cavern 106. However, it should be understood that a tunnel structure may extend beyond the plane of the page in an extended fashion consistent with a bored tunnel cavern structure, as described herein. The system 100 includes a motor/generator device 102 (“motor/generator” 102), a compressor/expander device 104 (“compressor/expander” 104), a storage cavern 106 and a gas pathway 112. The system 100 can be used, for example to store energy in the form of a compressed gas (e.g. air) in the storage cavern 106. The motor/generator 102 can be operatively coupled to a power supply (not shown in FIG. 1) and when power generation exceeds demand or when operational and market conditions otherwise warrant, the excess power can be directed from the power supply to the motor 102 to operate the compressor/expander 104 to store energy in the form of compressed air. When demand exceeds power generation, the compressed air can later be expanded through the compressor/expander 104 to drive the motor/generator 102, thereby generating power to supplement the power supply.

The compressor/expander 104 is in fluid communication with a source of gas such as, for example, a source of ambient air, and fluidly coupled via the gas pathway 112 to the storage cavern 106 to which gas can be transferred after being compressed. Valves can be used to open and close the fluid communication between the compressor/expander 104 and the source of gas and between the compressor/expander 104 and the storage tunnel 106. As the compressor/expander 104 delivers compressed gas to the storage cavern 106, the pressure within the storage cavern 106 increases until the pressure reaches a predetermined level and/or substantially equals the pressure of the compressed gas being delivered from the compressor/expander 104.

In some cavern storage applications such as, for example, described above with reference to FIG. 1, uncompensated fluid storage may be employed, wherein the pressure in the cavern is dependent on the quantity of fluid stored therein. However, uncompensated caverns may suffer from unacceptably large pressure variations as the cavern is charged with fluid and/or as fluid is removed. Such pressure variations may compromise the integrity of a storage cavern by, e.g., inducing mechanical and thermal stresses or hydraulic fractures in the tunnel walls. To address certain problems which may occur in uncompensated storage caverns, pressure compensation systems may be employed, such as those described in U.S. patent application Ser. No. 13/350,050, entitled “Compensated Compressed Gas Storage Systems,” the disclosure of which is incorporated herein by reference in its entirety.

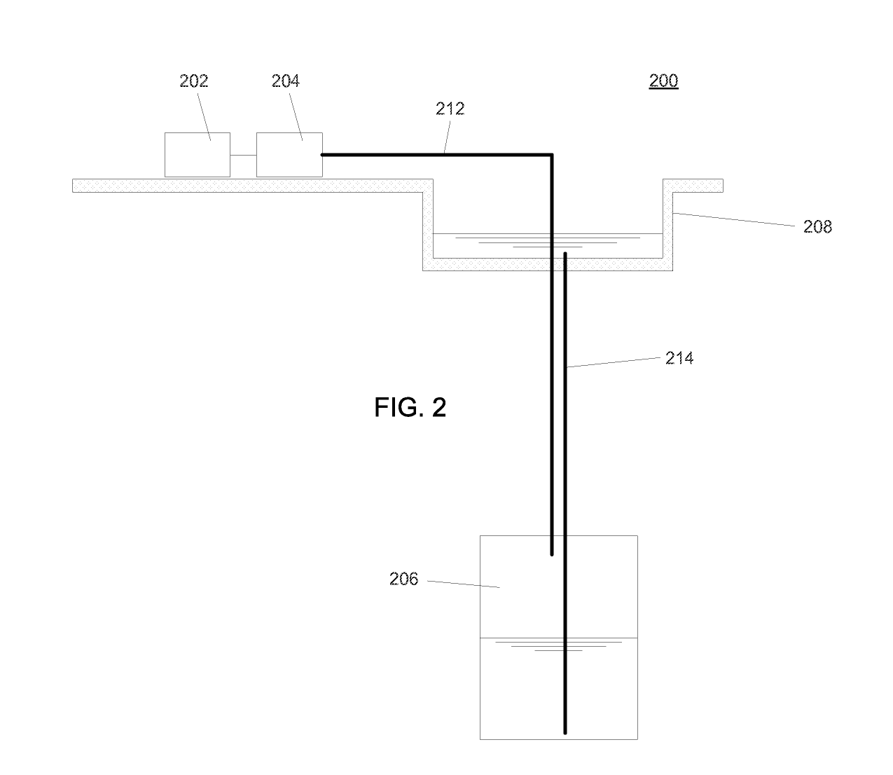

FIG. 2 is a schematic of a compressed gas storage/compressed gas energy storage system 200, employing a liquid pressure compensation technique with a “low storage” (e.g., the present cavern structures)/“high storage” (e.g., surface pool or tank) configuration. The system 200 includes a motor and/or generator device 202 (“motor/generator” 202), a compressor and/or expander device 204 (“compressor/expander” 204), a low fluid storage 206, a high fluid storage 208, a gas pathway 212, and a liquid pathway 214. The system 200 can be used, for example to store a commodity gas (e.g., natural gas), and/or to store energy in the form of a compressed gas (e.g., air) and/or pumped liquid (e.g., water, brine, fluids comprising weighting agents such as barite) in one or both of the low storage 206 and high storage 208. The system 200 can include a pump and/or generator (not shown in FIG. 2) disposed in the liquid pathway 214 between the low storage 206 and the high storage 208.

The motor/generator 202 can be operatively coupled to a power supply (not shown in FIG. 2). In compressed air energy storage applications, when power generation exceeds demand or when operational and market conditions otherwise warrant, the power can be directed from the power supply to the motor/generator 202 to operate the compressor/expander 204 to store energy in the form of compressed air. When demand exceeds power generation or when operational and market conditions otherwise warrant, the compressed air can later be expanded through the compressor/expander 204 to drive the motor/generator 202, thereby generating power to supplement the power supply.

The compressor/expander 204 can be in fluid communication with a source of gas such as, for example, a source of ambient air (at ambient pressure, or pre-pressurized by another compression system), and can also be fluidly coupled via the gas pathway 212 to the low storage 206 to which gas can be transferred after being compressed. Valves can be used to open and close the fluid communication between the compressor/expander 204 and the source of gas and between the compressor/expander 204 and the low storage 206. In some embodiments, the compressor/expander 204 can also be configured to operate as an expansion device to generate electricity. For example, the compressed gas can be transferred from the low storage 206 to the compressor/expander 204 and stepped down from a relatively high pressure to a relatively lower pressure. The energy released from this pressure differential can be used, for example, to generate electricity.

The low storage 206 can be configured to contain a compressed gas, such as, for example, compressed air. The low storage 206 may be a bored tunnel structure. As the compressor/expander 204 delivers compressed gas to the low storage 206, the pressure within the low storage 206 increases until the pressure reaches a predetermined level and/or substantially equals the pressure of the compressed gas being delivered from the compressor 204.

The low storage 206 can be configured to contain both the compressed gas and a liquid such as, for example, water or brine, at the first elevation. As the compressor/expander 204 delivers compressed gas to the low storage 206, the pressure within the low storage 206 increases until the pressure reaches a predetermined level and/or substantially equals the pressure of the compressed gas being delivered from the compressor/expander 204. After the pressure within the low storage 206 reaches the predetermined level and/or substantially equals the pressure of the compressed gas delivered from the compressor/expander 204, the liquid can be moved (or “displaced” by the compressed gas) out of the low storage 206 to another fluid storage location such as, for example, the high storage 208 via the liquid pathway 214. Furthermore, pressure within the low storage may be managed by controlled admittance of liquid from low storage 206 into high storage 208.

The high storage 208 can be in fluid communication with the low storage 206 via the liquid pathway 214 and configured to contain the liquid at a second elevation, higher than the first elevation. The high storage 208 can be, for example, a brine pond opened directly to the atmosphere at or near ground level. The pressure head of the liquid stored in the high storage 208 produces a pressure on the gas (and liquid) contained in low storage 206.

By employing a pressure compensation system, the pressure in a cavern storage structure can be held relatively constant throughout filling and/or discharge of the cavern, and delivery pressure of the stored gas may be kept relatively constant. This may avoid the problems associated with uncompensated storage of gases, including structural concerns due to over pressuring or under pressuring, or structural concerns due to relatively high rates of pressure change. Furthermore, in applications wherein a stored gas is to be employed to provide power generation (e.g., in a compressed air energy storage system), the delivery pressure of the stored gas can be relatively constant, providing a continuous, relatively constant delivery pressure to power-generation equipment (e.g., turbines), which can provide relatively constant energy generation.

In some embodiments, the present caverns have a relatively gradual and constant incline. Such a gradual, constant incline can prevent trapping of air and/or compensating fluid pockets in the present caverns. In some embodiments, a borehole at the terminus of a cavern may provide venting of the cavern during injection and/or removal of stored gases, for example, to prevent trapping of gas pockets during liquid injection. Further, when pressure compensation systems are employed, a venting system may prevent pockets of compensation liquids from being trapped.

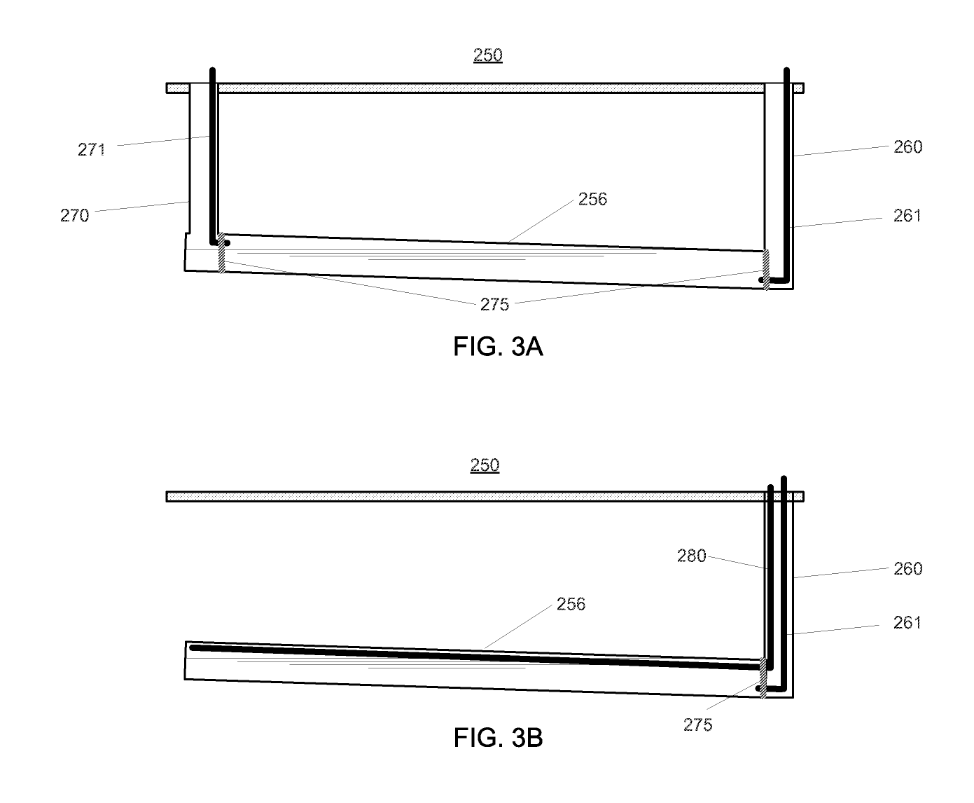

FIGS. 3A and 3B are schematic illustrations of embodiments of a storage system 250 including a cavern 256 that can be used to store liquids and/or compressed gases. For simplicity in rendering the present cavern structures, FIGS. 3A and 3B show a cross section of a cavern 256. However, it should be understood that a tunnel structure may extend beyond the plane of the page in an extended fashion consistent with a bored tunnel cavern structure, can be linear, curved (e.g., spirals, circles), or variations and combinations thereof (e.g., linear and curved portions may be combined in a single cavern structure), as described herein.

As shown in FIG. 3A, a central borehole 260 may have a cavern structure 256 extending at a slight incline off the bottom of the central borehole 260, and may further have a terminal borehole 270 at or near the terminus of the cavern structure 256. The terminal borehole 270 is fluidically coupled to the cavern structure 256 at a higher elevation than the central borehole 260 and thus can be used for gas injection and/or withdrawal and the central borehole 260 can be used for liquid injection and/or withdrawal when a compensating liquid is used as described herein. Alternatively, as shown in FIG. 3A, a pipe or conduit 261 may be employed to introduce and/or withdraw fluid from cavern 256. The cavern structure may further comprise seal or bulkhead structure 275, to provide pressure isolation of cavern 256. The terminal borehole 270 as shown in FIG. 3A can have a narrower diameter relative to the central borehole 260. In some embodiments, the terminal borehole 270 is utilized for venting and/or injection and removal operations as opposed to excavating the cavern structure 256, the terminal borehole 270 can be formed by traditional drilling and casing techniques. For example, the terminal borehole may have a diameter of from about 2″ to about 24″. Alternatively, as shown in FIG. 3A, a pipe or conduit 271 may be employed for venting and/or injection/withdrawal of fluids from cavern 256. In embodiments where pipe or conduit 271 is present, a bulkhead/seal 275 may be present to provide pressure isolation of cavern 256. In other embodiments, as described herein, where multiple cavern structures may be linked at their termini, the terminal borehole may be of similar size to the central borehole (i.e., of sufficient diameter to allow introduction of excavation/boring equipment). Alternatively, a single cavern may have a terminal borehole of comparable size to a central borehole.

Alternatively, as shown in FIG. 3B, a pipe or duct 280, or other fluid conduit, can extend from the surface, down the central borehole 260, and through the cavern structure 256 to the higher elevation terminus of the cavern 256. This pipe 280 can provide fluid communication between the higher elevation end of the cavern 256, which results from excavation of the cavern at an incline, and the surface or lower elevation of the cavern 256 at the central borehole 260. Accordingly, such a pipe 280 can provide a passageway for fluid injection and/or withdrawal in a similar manner as the terminal borehole 270 as described above.

In some embodiments, the depth of the cavern(s) may be selected based on the lithostatic pressure provided by the overburden of the rock formation in which the caverns are constructed so that the overburden is providing a compressive force on the cavern structure that is equal to or greater than the expansive force imposed on the cavern structure by the pressurized fluid. Said another way, at certain depths, the lithostatic pressure of the overburden can exert a force on an excavated cavern causing the cavern to deform or otherwise become structurally unstable. At greater depths in the same type of rock formation, the lithostatic pressure acting on the excavated cavern in the vertical direction can become more equalized with the pressure acting on the cavern in the horizontal direction, thus exerting forces on the cavern that are more stable. In some embodiments, the depth of the cavern can be selected such that the lithostatic pressure of the overburden is greater than that of the desired working pressure of the storage cavern. Operating the cavern in a regime where the lithostatic pressure is greater than that of the fluid storage pressure can prevent fractures in the cavern walls, which may be formed from fluid pressure exceeding the overburden pressure, i.e. by placing the walls of the cavern in tension rather than in compression.

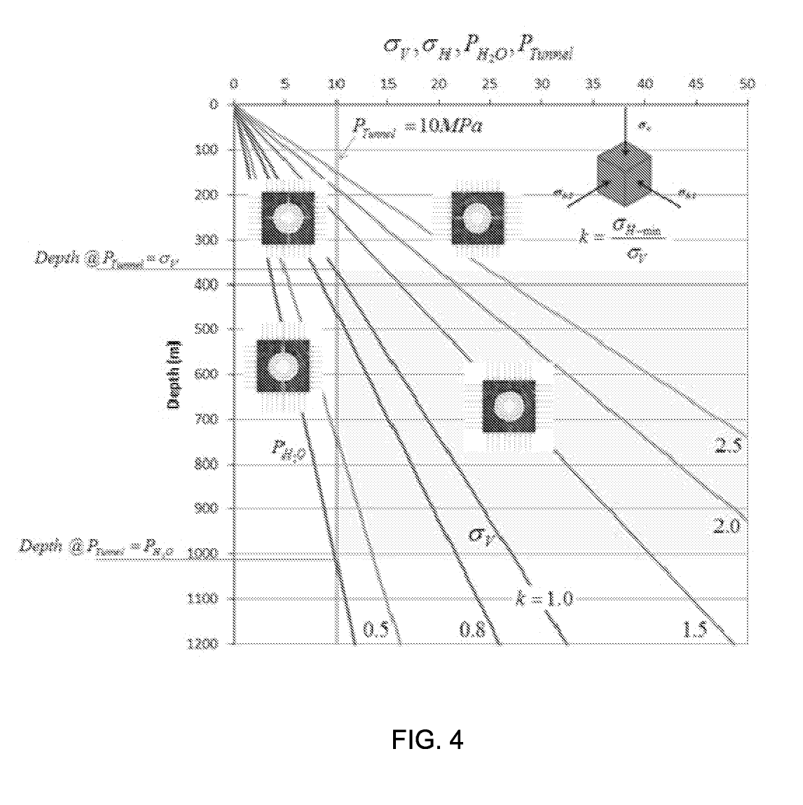

FIG. 4 is a plot of several stresses/pressures versus depth for cavern storage structures. The illustrated stresses/pressures are σ_{V} (stress on the cavern storage structure in the vertical direction), σ_{H} (stress on the cavern storage structure in the horizontal direction), P_{H2O} (hydrostatic pressure) and P_{Tunnel} (operating pressure of the stored fluid). FIG. 4 shows lines corresponding to various values of k, which is the ratio of the minimum horizontal stress σ_{H} (the horizontal stress may differ in different directions) to vertical stress σ_{V} of the rock formation. As shown, the depth of a cavern may be selected based on the desired working pressure P_{Tunnel} of the cavern, the k value for the rock formation in which the cavern is formed, and the hydrostatic pressure P_{H2O} at a given depth.

As shown in FIG. 4, the minimum depth of the cavern is selected such that the maximum working pressure P_{Tunnel} of the cavern is less than both the vertical stress σ_{V} and the horizontal stress σ_{H} at that depth, to avoid placing the wall of the cavern into tension (vertically and/or horizontally) and thus potentially fracturing the wall. The depth may also be selected so that the maximum working pressure P_{Tunnel} of the cavern is greater than or equal to the hydrostatic pressure P_{H2O} at that depth. Accordingly, cavern depth may be selected to provide a working pressure range between the vertical stress at that depth (i.e., the overburden pressure) and the hydrostatic pressure P_{H2O} at that depth.

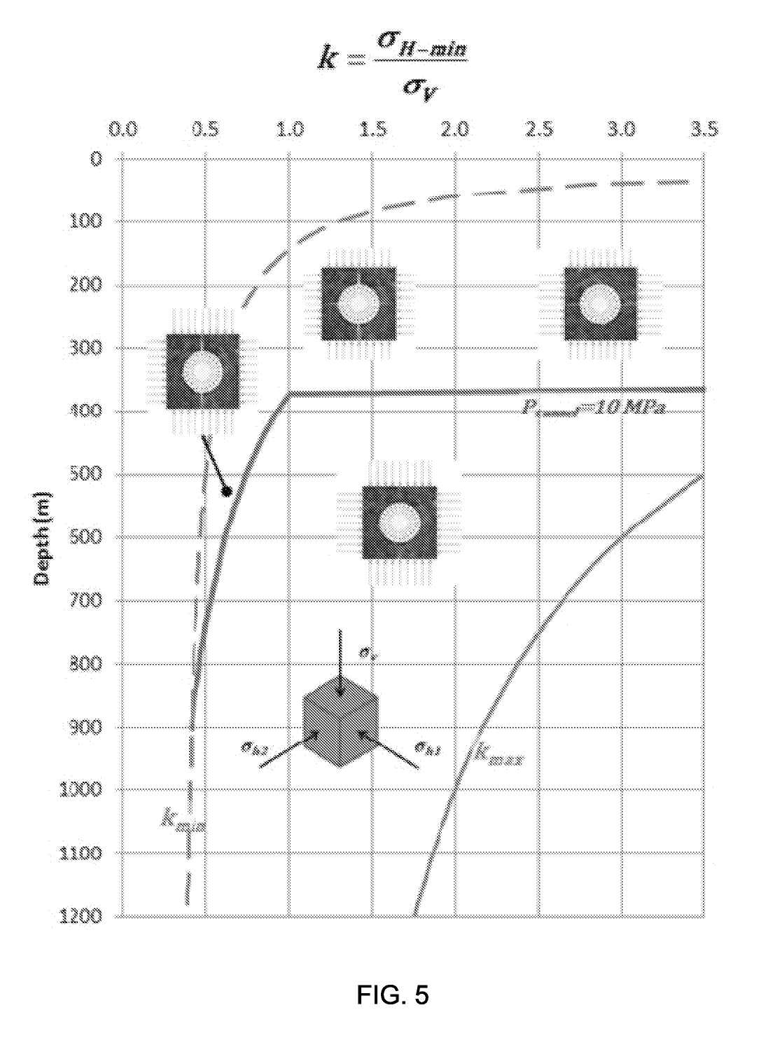

FIG. 5 is a plot showing a range of k values (kₘᵢₙ to kₘₐₓ) versus depth for a wide range of known rock formations. FIG. 5 illustrates that the range of k values narrows, converging towards a value of 1.0, with increasing depth. FIG. 5 also shows a desirable boundary line for the minimum depth of a cavern structure with a working pressure of 10 MPa. As shown, at depths above the boundary line, the working pressure exceeds the vertical stress σ_{V} and/or the horizontal stress σ_{H} (depending on the k value for the rock formation), which can lead to fracturing of the cavern wall. At depths below the boundary line, (e.g., slightly less than 400 m as shown) the vertical stress σ_{V} and the horizontal stress cm exceed the working pressure of the stored fluid (or when a pressure compensation fluid is employed, the pressure compensation fluid and the stored fluid), and the structural integrity of the cavern is not compromised, but may be enhanced by offsetting some of the vertical and horizontal stress.

In some embodiments, the system may operate with a cavern pressure greater than the hydrostatic pressure at the depth of the cavern (i.e. the pressure produced by a column of the compensating liquid equal in height to the depth of the cavern). For example, the cavern can be operated at a pressure in a range between the hydrostatic pressure P_{H2O} and lithostatic pressure or vertical stress σ_{V}. In some embodiments, the operating pressure of the cavern can be selected to optimize the compressed gas storage capacity of the cavern and provide structural integrity to the cavern. Said another way, increasing the operating pressure of the cavern increases the mass of compressed gas that can be stored in the cavern and can provide additional structural support for the cavern itself since the pressure differential between the lithostatic pressure and the pressure of the fluids being stored is reduced.

The operating pressure of the storage cavern can be increased above the hydrostatic pressure by pumping or otherwise increasing the pressure of the compensating liquid used in the system. For example, referring now back to FIG. 2, the system 200 can include a pump/turbine/positive displacement device (not shown) disposed in the liquid pathway 214 between the low fluid storage 206 and the high fluid storage 208. The pump/turbine/positive displacement device can be operated to increase the pressure of the compensating fluid in the low fluid storage 206, augmenting the hydrostatic pressure. Compressed gas entering the low fluid storage 206 displaces a portion of the liquid contained in the low fluid storage 206 when the pressure of the gas is greater than the operating pressure of the low fluid storage 206. As the pressurized liquid is displaced, the pump/turbine/positive displacement device can be used to recover the energy stored in the pressurized liquid so that the energy is not lost when the liquid flows into an atmospheric high fluid storage 208. Similarly, as liquid flows from the high fluid storage 208 to the low fluid storage 206 when compressed gas is being removed from the low fluid storage 206, the pump/turbine can be used to increase the pressure of the low fluid storage above the hydrostatic pressure. Alternatively, a pressurized high fluid storage 208 as well as other types of pump arrangement can be utilized to raise the operating pressure of the low fluid storage 206 above the hydrostatic pressure.

Embodiments of the storage caverns can be installed below natural and man-made surface features that have depth; such as, within quarries, mines, at the base of hydro-dams, at the bottom of canyons, into the side of cliffs, mountains, near oceans or other bodies of water (e.g. lakes or reservoirs). The lithostatic stress below these features reflects the stress at a depth measured from the top of these features. The apparent depth, for reaching the caverns, is shallower then the depth that defines the lithostatic stress in the formation (top of the surface feature). This results in potentially lower cost to bore a shaft to the cavern. There is also value in co-locating the construction site for a cavern at an existing mine or quarry because the site already has much of the industrial and regulatory accoutrements required to construct the caverns. If co-located at the base of a hydro-electric dam, a CAES unit utilizing cavern air storage may utilize the power lines at the site distributing power for the dam, and the water head behind the dam will assist in the pressure compensation requirements of the tunnel air storage.

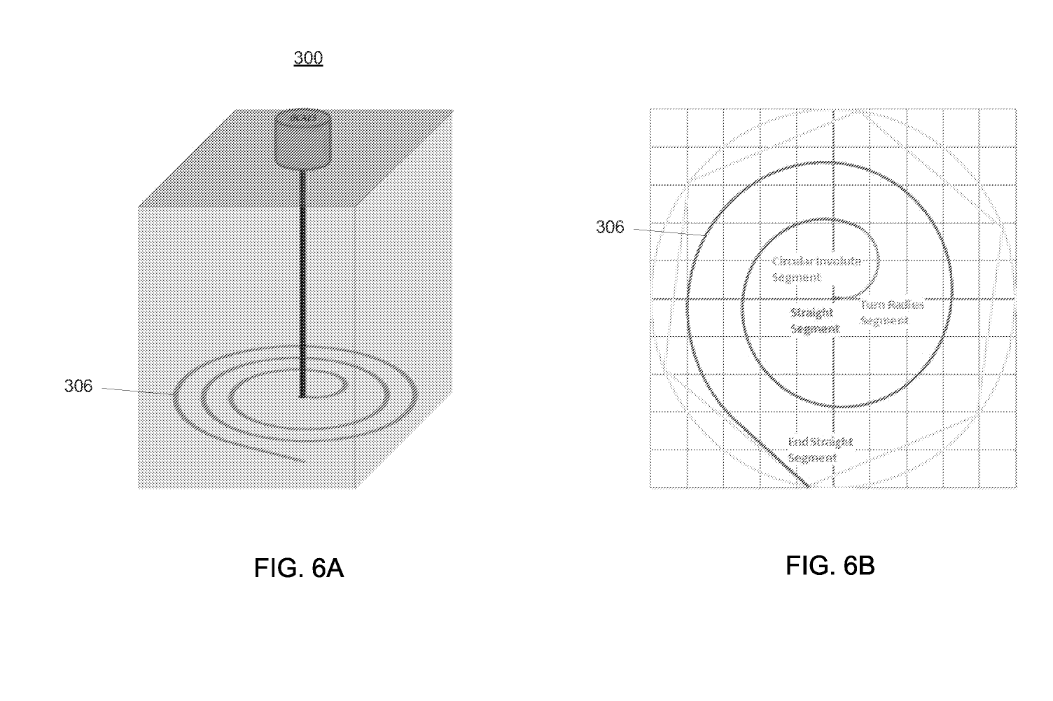

FIGS. 6A and 6B are schematic illustrations of a storage system 300 that can be used to store liquids and/or compressed gases. As shown, a cavern 306 may be bored off a central borehole. The cavern 306 may be substantially linear in an initial straight segment. This can allow for a TBM to cut into the rock in which the cavern 306 is to be formed, and the TBM can begin to turn at a constant turn radius, e.g. at its minimum turn radius. The TBM can then cut in a circular involute pattern, which has a continuously increasing radius and thus a spiral shape. Finally, the TBM can cut a straight segment. The spiral shape shown can provide a high storage volume in a given surface area of land, thus providing high storage density. The radius of the spiral segment is not particularly limited. Generally the radius of a spiral cavern may be chosen in view of the turning capabilities of the TBM. In addition, the radius may be selected to provide desired spacing between arcs of the spiral. Further, as described herein, the radius of the arc may be selected such that additional spirals or other patterns can be incorporated in a cavern array. The use of non-linear caverns, such as the spiral shape shown in FIGS. 6A and 6B, allows for a high effective length of the storage cavern while minimizing the overall land area required for such a cavern. Furthermore, if certain geologic characteristics of a site (e.g., faults, very hard rock, acidic rock, etc.) that constrain the area available in a given site, the present spiral pattern can allow for construction of the storage cavern while avoiding undesirable geologic features. Further, as described above with respect to FIG. 1 and FIG. 2, the present cavern structure may be operated in an uncompensated manner, or may employ a pressure compensation system.

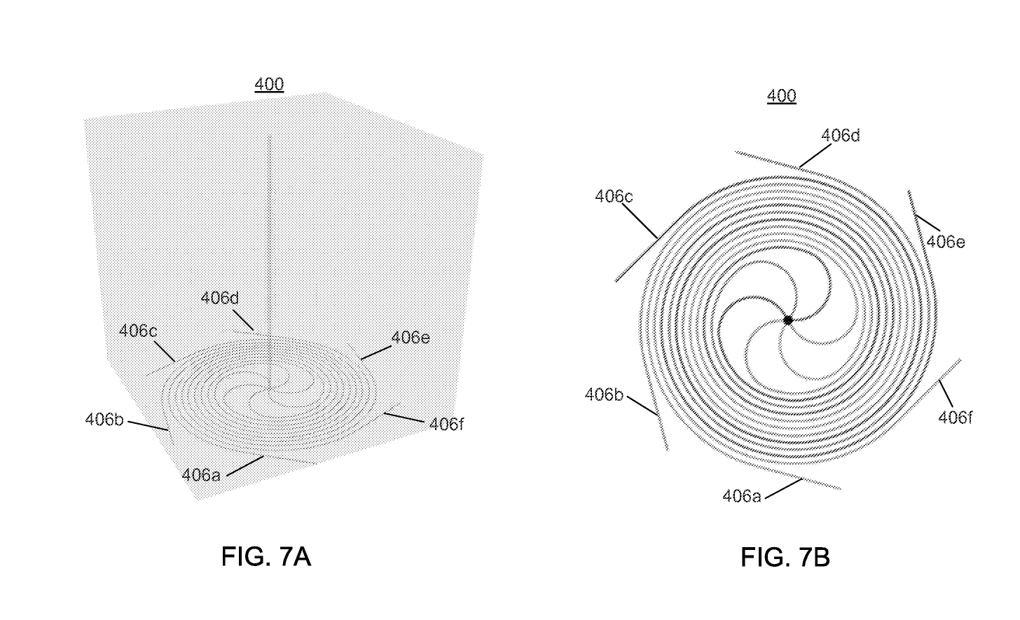

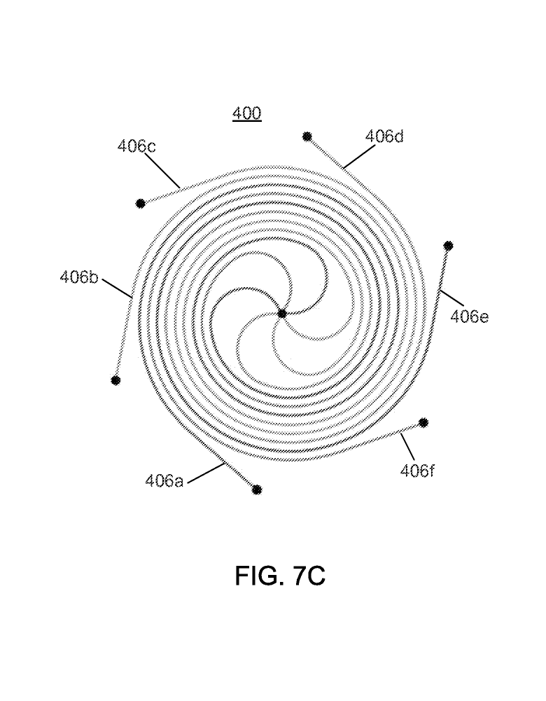

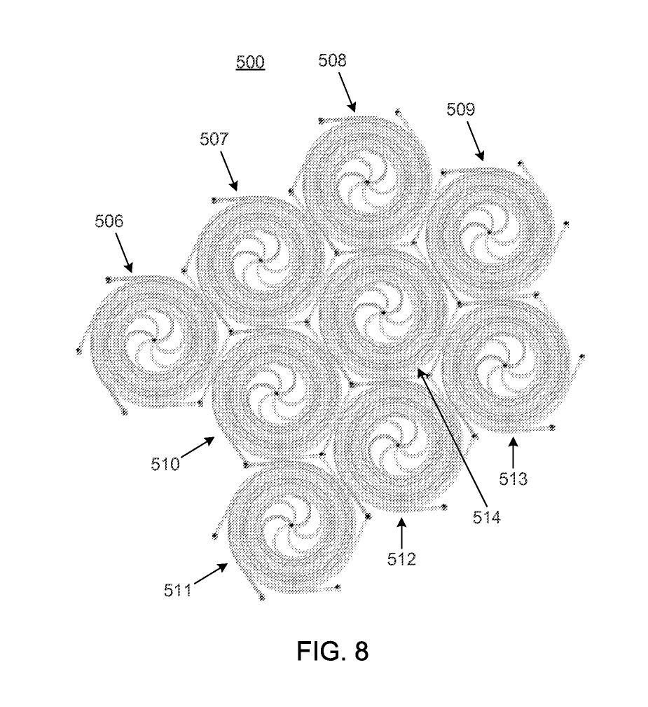

Individual caverns may also be combined in an array. For example, FIG. 7A is a perspective view of a storage structure 400, comprising a plurality spiral cavern storage structures 406a-f. FIG. 7B is a top view of the plurality of spiral storage structures of FIG. 7A. As described above with respect to FIGS. 6A and 6B, the present caverns may have a spiral shape. As shown in FIGS. 7A and 7B, several spiral caverns, 406a-f, can be formed off a single vertical borehole. For example, the cost of a vertical borehole described herein may be substantial. Accordingly, constructing several caverns off a single central borehole may provide significant cost savings in constructing a storage facility, since a single vertical access borehole can serve as the access point for constructing several caverns. In addition, as shown in FIG. 7A, the spiral patterns can be nested together to provide maximum storage density per unit land area. In addition, the cutting from multiple caverns off a single vertical borehole can be removed with a single train of debris removal equipment.

The spacing of the nested spirals shown in FIGS. 7A and 7B is not particularly limited. Spacing of the spiral may be determined by the cutting radius of the TBM. Spacing may also be determined by the minimum rock thickness needed to provide pressure isolation between adjacent arms of each spiral cavern. For example, in an array where different caverns may be employed for different fluids, or for the same fluid but at different pressures, typically each spiral will be fluidically isolated from the others. For example, in one embodiment, the present caverns may be used to store compressed air, and one or more caverns may be used for discharge of the compressed air to, e.g., an energy generation system, while one or more adjacent caverns may simultaneously be employed to receive compressed air while the one or more adjacent caverns are discharging air. Thus, an array of caverns as shown in FIGS. 7A and 7B can be employed to store multiple fluids, and introduction and discharge operations may be conducted simultaneously in multiple, fluidically isolated caverns off a single central vertical borehole. Accordingly, a minimum rock thickness (e.g., spacing) between spirals may be selected to provide mechanical and pressure integrity of adjacent caverns.

While the nested spiral array of FIGS. 7A and 7B has an array of six nested spiral caverns (i.e., segments 406a-f) off a single central borehole, the present array of caverns is not limited to a particular number of caverns off a central borehole. The number of caverns extending off a central borehole may be selected to maximize the aggregate length of cavern off a single borehole. Further, a larger central borehole may provide more circumferential area to construct additional caverns off a central borehole. Thus, a larger central borehole may allow for the construction of more caverns off the central borehole. The number of caverns off a central borehole may be selected in view off the spacing requirements between individual caverns (e.g., for pressure isolation or mechanical stability of the bored caverns). Furthermore, while FIGS. 7A and 7B illustrate an array of nested spiral shapes, the present cavern arrays are not limited to spiral arrays. In some embodiments, the present arrays may comprise, for example, internally or externally tangent circles which may be interconnected via a common tangent point coincident with the central borehole. Alternative arrays may also include radial spoke shapes, which may be straight or curved. As described above, the shape of the present caverns and cavern arrays are not limited, and a particular geometry for single caverns or cavern arrays may be selected in view of local geologic conditions or a desired storage density.

In some embodiments, multiple boreholes can be used, for example, at the beginning and the end of each individual cavern. FIG. 7C is a top view of a plurality of spiral storage structures similar to those shown in FIG. 7B with a vertical borehole at the beginning and end of each cavern. Having a vertical borehole at the beginning and end of each cavern can increase the speed at which the caverns can be excavated by allowing the use of multiple excavating machines (e.g., TBMs). The multiple boreholes can also provided fluid passageways as described above with respect to FIGS. 3A and 3B. Furthermore, the vertical borehole at the end of one cavern can be used as a vertical borehole at the beginning of another cavern or caverns to create nested arrays as described herein.

Individual caverns in an array may have the same or similar geometry (e.g., length, diameter, plan geometry). Alternatively, in some embodiments, individual caverns in an array may have different geometries. For example, a spiral array may include individual spirals having different lengths. The length of individual caverns may be selected such that the termini are arrayed for interconnection. In other embodiments, individual caverns may have different shapes (e.g., circles, spirals, linear or zigzag shapes) which may be combined in array. Such combinations may allow for avoidance of undesirable geologic features, or may facilitate interconnection of individual caverns. For example, an array may comprise spiral caverns and straight caverns intersecting one or more segments of spiral caverns in an array. Alternatively, in some embodiments, tangent circles, spiral, and straight segments may be combined to provide an interconnecting array of caverns. The combination of shapes in the array is generally limited only by the technical limitations of, e.g., a TBM to cut those shapes (e.g., turning radius).

Some embodiments may combine cavern geometries in an array to, e.g., allow for expeditious removal of cutting debris during the formation of the array, or to allow for use of excavated portions of a cavern or cavern array while other portions are being constructed. Thus, a storage cavern array can be constructed and certain portions of individual caverns or portions of an array may be used for storage of fluid while constructing other portions of a cavern array. In such embodiments, pressure isolation of potions of single cavern, several individual caverns, or portions of an array of caverns may be fluidically isolated as described herein to allow for use of completed portions of an array, while construction of other portions of an array are being constructed. Thus, the present array can provide a high degree of flexibility for simultaneous construction of caverns while employing portions that have previously been constructed for storage applications.

In addition, as described above with respect to FIG. 1 and FIG. 2, the present cavern structures may be operated in an uncompensated manner, or may employ a pressure compensation system. Furthermore, where individual caverns in an array are fluidically isolated from each other, some caverns may employ pressure compensation, whereas other caverns may be operated without pressure compensation. In some embodiments, two or more pressure compensation systems may be employed to provide pressure compensation of individual caverns or groups of caverns which are fluidically isolated. Such systems may provide additional flexibility in operation of multi-cavern arrays.

FIG. 8 is a schematic illustration of another embodiment of a storage structure 500. FIG. 8 shows an array of the nested spiral patterns shown in FIGS. 7A-7C, numbered 506 to 514. Several of the spiral arrays shown in FIGS. 7A-7C can be arrayed with a series of vertical boreholes to provide a very high density storage structure for a given land area. Such an array can be constructed with a series of vertical boreholes placed to allow for the termini of the individual spirals to interconnect. Thus, the spiral array can provide very high storage volumes in an interconnected array of nested spiral arrays. The number of arrays which can be interconnected is not particularly limited. For example, while FIG. 8 shows an array of nine individual nested spiral arrays, an array may include more or fewer depending geologic considerations and storage capacity requirements. For example, the number of interconnecting arrays may be limited by the need to avoid undesirable geologic features as described above (e.g., faults, acidic rock, very hard rock, etc.), or may be limited by the area of surface land, or area of mineral rights, available for construction of the storage facility.

As shown in FIG. 8, an array of nested spiral patterns may include multiple vertical boreholes. The location of vertical boreholes may be selected to allow for interconnection of individual caverns or cavern arrays. Such interconnection of individual caverns via vertical boreholes may allow for more rapid and/or efficient removal of excavated material. Further, the use of multiple boreholes may facilitate the use of constructed caverns for storage applications while other caverns in an extended array are constructed. As shown in FIG. 8, the total storage density may be high for a given area, and the number of individual caverns and cavern arrays may be selected to maximize storage area density.

The parameters described above with respect to individual caverns and cavern arrays are applicable to patterns of arrays. For example, a single array may comprise multiple shapes or geometries of individual caverns, and individual caverns of different geometries may be interconnected in a single array. Then a single array, comprising several caverns of differing geometries, can be configured to provide an extended array of either isolated or interconnected caverns with varying individual cavern geometries. Similarly, multiple arrays may be interconnected by straight or curved segments, and multiple arrays may be connected by one or more vertical boreholes. Further, various array geometries may be combined in an extended array. For example, in some embodiments, a single array of spiral caverns may be coupled or interconnected to other array geometries. In certain embodiments, an array of cotangent circles (e.g., internal, external) can be combined with one or more spiral arrays, linear arrays, or combinations thereof. The overall plan geometry is not limited, and the selection of shapes may be selected to minimize excavation costs, and/or to avoid undesirable geologic features while maximizing storage area. Furthermore, the present extended arrays may allow for planning and construction of a storage facility to allow for use of some excavated caverns in an array while other caverns are constructed. Furthermore, the overall plan geometry of an extended array of caverns can be selected to minimize construction costs, avoid undesirable geologic features, and/or maximize storage density. Further, as described above, the present extended cavern arrays may be operated in an uncompensated manner, or may employ a pressure compensation system. In the present extended arrays, different arrays can be either interconnected or selectively isolated or interconnected to provide multiple extended caverns with different working pressures.

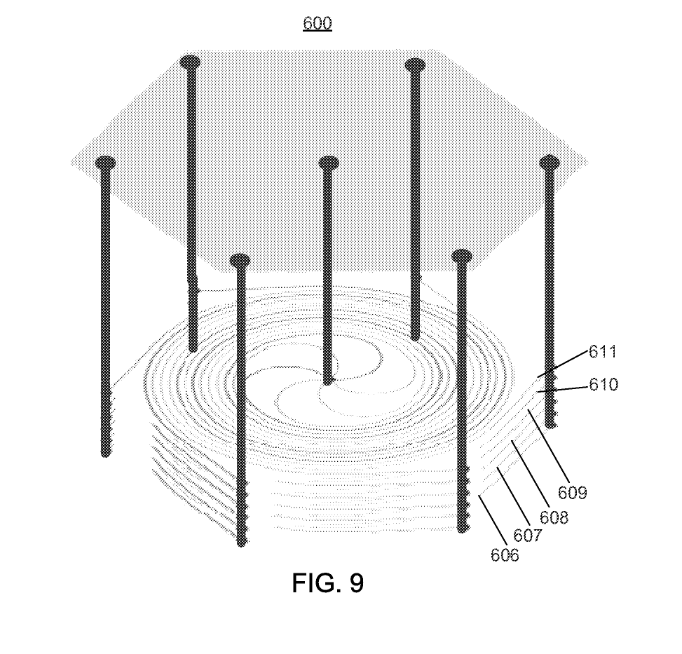

In some embodiments, the caverns may also be constructed in a three-dimensional array. FIG. 9 is a schematic illustration of another embodiment of a storage structure 600, which is a three-dimensional array of the spiral array of FIGS. 7A-7C. As shown, two or more arrays can be constructed in a vertical array. Such a vertical array can provide even greater storage densities, by combining the increased storage density of a two-dimensional array of the present caverns in a three-dimensional arrangement. The number of arrays which may be oriented in a vertical array is not particularly limited. Thus, while FIG. 9 shows a vertical arrangement of six spiral arrays, numbered 606 to 611, in some embodiments, as few as two vertically disposed arrays may be constructed. Alternatively, many vertical arrays (e.g., 3, 4, 5, 6, 7, 8, 9, 10 or more) vertically disposed may be employed. The number and depth of such vertical arrays may be determined by the required lithostatic pressures for a given storage application. Furthermore, in storage applications wherein multiple types of fluids are to be stored, deeper arrays, which exhibit higher lithostatic pressures, may be employed to store fluids where higher working pressures are employed. For example, in embodiments where compressed air is to be stored, deeper arrays in a vertical arrangement may be employed for compressed air storage, while shallower arrays may be employed for storage of liquids.

Vertical spacing of arrays may be determined based on rock strength and properties of the geologic formation in which the present storage caverns are constructed. For example, spacing may be selected to ensure mechanical stability of vertically disposed caverns, and to ensure fluidic isolation of each level of caverns in a vertical arrangement. In addition, as described above, a cavern or caverns at a first depth can be fluidically isolated from a cavern or caverns at a second depth (e.g., deeper or shallower) such that each level of cavern(s) may be operated at different working pressures. Alternatively, a cavern or caverns at a first depth can be connected to a cavern or caverns at a second depth (e.g., deeper or shallower) for operation at the same or similar working pressure. Selection of depths and number of levels in a vertical arrangement of caverns or arrays of cavern may selected such that the lithostatic pressure differential from the top of a vertical arrangement to the bottom of a vertical arrangement is small enough to allow for interconnection of multiple levels, and allow for use of the vertical arrangement of caverns to be operated over a selected working pressure.

As shown in FIG. 9, a vertical arrangement of arrays may be interconnected by vertical boreholes. The present vertical arrangement of horizontal arrays may allow for excavation of multiple levels of caverns employing common vertical borehole. Thus, while FIG. 9 shows a six-level vertical arrangement of spiral arrays, including a central vertical borehole and six vertical boreholes at the termini of the spiral arms on each level of the vertical array, alternative embodiments may employ a single central borehole for a vertical arrangement of arrays. Alternatively, two or more (e.g., 2, 4, 5, 6, 7, 8 or more) vertical boreholes may be employed in a vertical arrangement of horizontal arrays. The present vertical arrangement of horizontal arrays may provide for multiple entry points for two or more TBMs. This can allow for simultaneous construction of multiple caverns. Furthermore, as described above, the overall plan geometry, and vertical arrangement, may be selected such that as portions of a horizontal array and/or or entire levels in a vertical array can be fluidically isolated, optionally interconnected, and employed in storage operations while other portions of a horizontal array, an entire level of an array, or multiple levels of an array can are constructed.

Vertical arrangements of horizontal arrays may employ levels of caverns having the same geometry, or individual levels may employ different geometries. For example, certain levels may comprise caverns with geometries selected to avoid undesirable geometric features, while other levels may, in the absence of such geologic features at the level which they are constructed, need not terminate to avoid such features. Accordingly, design considerations applicable to single caverns, arrays of caverns, and interconnected arrays of caverns on a single level are also applicable to the present vertical dispositions of caverns and/or cavern arrays. Accordingly, multiple geometries, number of caverns, length of individual caverns, number of vertical boreholes, sharing of vertical boreholes between individual caverns, and spacing of caverns both vertically and horizontally, may be selected to maximize the storage density for a given area.

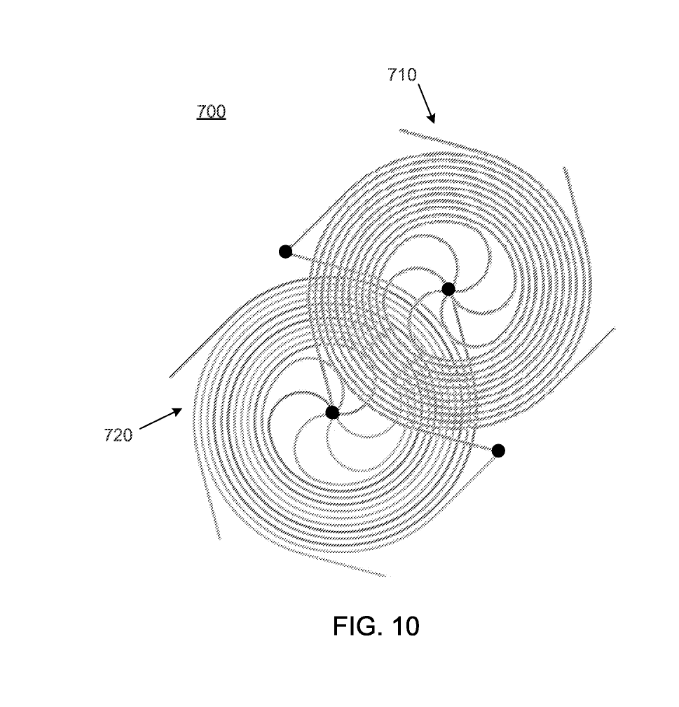

FIG. 10 is a schematic illustration of another embodiment of a storage structure 700. FIG. 10 shows an array of the nested spiral patterns shown in FIGS. 7A-7C, numbered 710 and 720. The spiral arrays shown in FIGS. 7A-7C can be arrayed in an overlapping pattern, with vertical boreholes intersecting the overlapping spiral patterns at selected termini to provide a high density storage structure for a given land area. Such an array can be constructed with vertical boreholes placed to allow for the termini of the selected individual spirals to interconnect. Thus, the overlapping spiral array can provide very high storage volumes in an interconnected array of overlapping spirals. The number of spirals that can be interconnected via overlapping is not particularly limited. For example, while FIG. 10 shows an overlapping spiral array of two individual nested spiral arrays, an array may include more or fewer depending on geologic considerations, storage capacity requirements and mechanical characteristics of the rock in which the caverns are constructed. For example, the number of overlapping arrays may be limited by the need to avoid undesirable geologic features as described above (e.g., faults, acidic rock, very hard rock, etc.), or may be limited by the area of surface land, or area of mineral rights, available for construction of the storage facility.

As shown in FIG. 10, an array of overlapping nested spiral patterns may include multiple vertical boreholes. The location of vertical boreholes may be selected to allow for interconnection of individual caverns or cavern arrays. Such interconnection of individual caverns via vertical boreholes may allow for more rapid and/or efficient removal of excavated material. Further, the use of multiple boreholes may facilitate the use of already-constructed caverns for storage applications while other caverns in an extended array are still being constructed. As shown in FIG. 10, the total storage density may be high for a given area, and the number of individual caverns and cavern arrays may be selected to maximize storage area density.

The present caverns, and combinations of individual caverns in horizontal arrays, interconnection of horizontal arrays, and vertical disposition of horizontal arrays provides a wide range of design, construction and installation possibilities to provide increased storage density, design flexibility, and freedom with respect to location of a storage facility relative to conventional subsurface storage facilities (e.g., salt domes, depleted hydrocarbon reservoirs). Furthermore, the use of surface manifolds, selective interconnection of caverns, arrays and levels, coupled with pressure compensation systems, allows for a many possible combinations which confer a high degree of flexibility for operation of the present storage caverns and facilities employing those caverns, e.g., in compressed air energy storage and generation facilities. Accordingly, embodiments of the present invention provide high density storage facilities, and may provide a cost effective alternative to conventional subsurface and above ground storage facilities, which may be conveniently located for specific applications.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the invention. As such, the invention is not to be defined only by the preceding illustrative description, but rather by the claims.

1. A large-scale, excavated, underground storage system comprising:
at least one substantially vertical borehole having a first diameter; and
a plurality of lateral caverns extending from the vertical borehole and adapted for substantially sealed storage of a fluid, each lateral cavern excavated by a tunnel boring machine and having a second diameter less than or substantially equal to the first diameter,
wherein the lateral caverns are formed to substantially maximize a volume of the lateral caverns while substantially minimizing a total surface area of the storage subsystem.

2. The storage system of claim 1, wherein the storage system is fluidically coupled to a compressed air energy storage system.

3. The storage system of claim 1, wherein the first diameter is sized to receive the tunnel boring machine.

4. The storage system of claim 1, wherein each lateral cavern is one of substantially horizontal and inclined.

5. The storage system of claim 1, wherein at least one of the lateral caverns is fluidically isolated from at least one other of the lateral caverns.

6. The storage system of claim 1, wherein at least one of the lateral caverns is fluidically coupled to a substantially vertical terminal borehole disposed at a terminal end of that lateral cavern.

7. The storage system of claim 1, wherein each of the lateral caverns comprises a geometry selected from the group consisting of a line, a curve, a circle, a spiral, and combinations of the foregoing.

8. The storage system of claim 7, wherein each of the lateral caverns comprises a substantially similar geometry.

9. The storage system of claim 7, wherein at least one of the lateral caverns comprises a circular cross-section.

10. The storage system of claim 7, wherein the lateral caverns are arranged in one of a two-dimensional array and a three-dimensional array.

11. The storage system of claim 1, wherein the fluid is selected from the group consisting of a liquid, a gas, a vapor, a suspension, an aerosol, and combinations of the foregoing.

12. The storage system of claim 1, wherein a depth of at least one of the lateral caverns is selected based at least in part on a lithostatic pressure acting on that lateral cavern.

13. The storage system of claim 1, further comprising a pressure compensation system adapted to maintain a substantially constant working pressure in at least one of the lateral caverns.

14. The storage system of claim 13, wherein the pressure compensation system comprises a liquid displaceable by a gas stored in the at least one of the lateral caverns.

15. A method for constructing a large-scale, excavated, underground storage system, the method comprising:
forming at least one substantially vertical borehole having a first diameter; and
excavating, by a tunnel boring machine, a plurality of lateral caverns extending from the vertical borehole and adapted for substantially sealed storage of a fluid, each lateral cavern having a second diameter less than or substantially equal to the first diameter,
wherein excavating the lateral caverns comprises forming the lateral caverns to substantially maximize a volume of the lateral caverns while substantially minimizing a total surface area of the storage subsystem.

16. The method of claim 15, further comprising fluidically coupling the storage system to a compressed air energy storage system.

17. The method of claim 15, wherein the first diameter is sized to receive the tunnel boring machine.

18. The method of claim 15, wherein each lateral cavern is one of substantially horizontal and inclined.

19. The method of claim 15, further comprising fluidically isolating at least one of the lateral caverns from at least one other of the lateral caverns.

20. The method of claim 15, further comprising fluidically coupling at least one of the lateral caverns to a substantially vertical terminal borehole disposed at a terminal end of that lateral cavern.

21. The method of claim 15, wherein each of the lateral caverns comprises a geometry selected from the group consisting of a line, a curve, a circle, a spiral, and combinations of the foregoing.

22. The method of claim 21, wherein each of the lateral caverns comprises a substantially similar geometry.

23. The method of claim 21, wherein at least one of the lateral caverns comprises a circular cross-section.

24. The method of claim 21, further comprising arranging the lateral caverns in one of a two-dimensional array and a three-dimensional array.

25. The method of claim 15, wherein the fluid is selected from the group consisting of a liquid, a gas, a vapor, a suspension, an aerosol, and combinations of the foregoing.

26. The method of claim 15, further comprising selecting a depth of at least one of the lateral caverns based at least in part on a lithostatic pressure acting on the lateral cavern.

27. The method of claim 15, further comprising maintaining a substantially constant working pressure in at least one of the lateral caverns.

28. The method of claim 27, wherein maintaining a substantially constant working pressure comprises displacing a liquid by storing a gas in the at least one of the lateral caverns.
